(19) United States
(12) Patent Application Publication
(10) Pub. No.: US 2019/0139045 A1
(43) Pub. Date: May 9, 2019

(54) Securing Multi-Part Network Transactions with Automated Multi-Phase Network Traversal

(71) Applicant: ITS, INC., JOHNSTON, IA (US)

(72) Inventors: Terry Dooley, West Des Moines, IA (US); Manish Nathwani, Johnston, IA (US); Stephan Thomasee, Johnston, IA (US); Scott Dobesh, Clive, IA (US)

(21) Appl. No.: 16/239,345

(22) Filed: Jan. 3, 2019

Related U.S. Application Data
(63) Continuation-in-part of application No. 13/555,963, filed on Jul. 23, 2012.

(51) Int. Cl. G06Q 20/40; H04L 9/32

(52) U.S. Cl. CPC G06Q 20/4012; G06Q 2220/00; H04L 2209/56; H04L 9/321

(57) ABSTRACT

Various embodiments automate an authorization for a partial amount in a pre-authorized transaction via a unique data element that uniquely identifies the pre-authorization and does not require multiple traversals over the network of a CAV (e.g., a four-digit pin). In this way, one type of network traversal for pre-authorization (e.g., of a total amount) is utilized via communicating an encrypted CAV, and another type of automated traversal is utilized to complete subsequent corresponding transaction requests (e.g., for partial amounts) via the unique data element (without the CAV). Thus, each portion of a pre-authorized transaction may be transferred individually without repetitively verifying the CAV. In other words, the CAV may be authenticated during the authorization/pre-authorization phase. Thereafter, the CAV need not traverse the network again. Instead, the unique data element is automatically included in processing transaction requests for authorization purposes, providing for greater security measures and network efficiencies.

### CROSS REFERENCE TO RELATED APPLICATIONS

This application is a continuation-in-part and claims priority to U.S. patent application Ser. No. 13/555,963 filed Jul. 23, 2012, entitled SYSTEM AND METHOD FOR DUAL MESSAGE CONSUMER AUTHENTICATION VALUE-BASED EFT TRANSACTIONS, Attorney Docket No. 41057.268233, which is assigned or under obligation of assignment to the same entity as this application, the entire contents of the application being herein incorporated by reference.

### BACKGROUND

In client-server transaction computer networks, traversal over these networks can be costly in terms of data security, network traffic exchange, and transfer amount functionality among other things. For instance, each time a consumer authentication value (CAV) (e.g., a four-digit PIN) is received for authentication associated with a transaction, the received CAV is communicated over the transaction network, which is a security vulnerability. In an illustrative example, if a purchase order requires that smaller portions thereof need to be independently processed for payment, conventional systems require that the CAV be manually entered at a terminal, received by the terminal, and communicated among the relevant computing entities to authorize and process the portioned payment. Requiring an account holder to provide a CAV for each related transaction is inefficient, requiring both manual intervention and the redundant utilization of computing resources, such as the devices (e.g., terminal devices, PIN pads, servers) for receiving the CAV or for processing the related transaction. While the CAV could be stored in a memory for processing related transactions, storing the CAV in plain-text is insecure for obvious reasons, as storing a plaint-text CAV is susceptible to likely brute force attacks provided that most CAVs include only four-digit numerical pins (e.g., as opposed to 8 digit passphrases that require numbers and letters). Further, the constant communication of the CAV heightens the risk of successful eavesdropping and data sniffing. Conventional client-server transaction networks are only able to provide basic functionality for authorizing and processing a total amount of an order, and does not provide a secure or efficient means for authorizing and processing partial amounts of a larger purchase order based on a pre-authorization of the purchase order, as described in more detail herein.

### SUMMARY

Embodiments of the present invention relate to client-server transaction networks. More particularly, embodiments relate to automating a dual-phase network traversal via a unique data element.

In various embodiments, a unique data element (UDE) processing device receives a pre-authorization request from an acquisition device configured to generate the pre-authorization request based on an initiated pre-authorization transaction. The received pre-authorization request includes an encrypted consumer authentication value (CAV) and defines a total amount associated with the initiated pre-authorization transaction. The UDE processing device generates a verification request based on the encrypted CAV and the defined total amount included in the received pre-authorization request. The UDE processing device communicates the generated verification request to a verification server. The verification server is configured to generate a verification response based at least in part on the communicated verification request. The UDE processing device generates a unique data element based on the generated verification response being received from the verification server. The generated unique data element is associated with the generated verification response and is communicated to the acquisition device as a response to receiving the verification response. The UDE processing device receives a first processing request from the acquisition device. The acquisition device is further configured to generate the first processing request based on an initiated first processing transaction associated with the communicated verification response. The UDE processing device authorizes the received first processing request based on a determination that the received first processing request includes the generated unique data element and defines a first amount less than the defined total amount.

In client-server transaction computer networks, there is no functionality that automates an authorization for a partial amount and pre-authorizes a total amount. Further, typical client-server transaction computer network functionality requires repetitive communication of a CAV. Particular embodiments of the present disclosure improve these client-server transaction computer networks by employing functionality that automates an authorization for a partial amount and does not require multiple traversals over the network of the CAV by using a unique data element that uniquely identifies an authorization. In this way, dual-phase traversal of the network is generated to complete transactions—one type of network traversal for pre-authorization (e.g., of a total amount) and another type of automated traversal for settlement advice requests (e.g., for partial amounts). Thus, each portion of the total amount associated with the corresponding settlement advice requests maybe be transferred individually without authorization using the CAV. In other words, the CAV may be authenticated during the authorization/pre-authorization phase. Thereafter, the CAV need not traverse the network again. Instead, the unique data element is automatically included in processing requests for authorization purposes. This enhances security, removes any tedious and time consuming manual actions needed from users to input the CAV, reduces network traffic exchange, reduces bandwidth utilization, and decreases storage device I/O, as described in more detail herein.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example of a system for processing dual message CAV-based funds transfers, according to various implementations of the invention.

FIG. 2 is a data flow diagram illustrating exemplary process relationships in a system for processing dual message CAV-based funds transfers, according to various implementations of the invention.

FIG. 3 is a flow diagram illustrating an example of a process for processing dual message CAV-based funds transfers, according to various implementations of the invention.

FIG. 4 is a block diagram illustrating an example computing device in which aspects of the present disclosure are employed in, according to various implementations of the invention.

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Existing client-server transaction network technologies employ functionality that requires the input of a consumer authentication value (CAV) at each step, which is often communicated over these networks several times to complete transactions. Specifically, these networks require the CAV for each communication between components of these networks in order to complete a transaction only for a total amount. However, there is no functionality for a preauthorization of a total amount and providing automated settlement for partial amounts of the overall total via any unique data structures.

Various embodiments of the present disclosure improve these existing client-server transaction technologies via new functionalities that these technologies or computing devices do not now employ. For example, particular embodiments perform dual-phase network traversal by obtaining pre-authorization for a total amount, which does not require multiple traversals over the network of the CAV. Instead, a unique data structure or data element that uniquely identifies an authorization is used for processing. In this way, one type of network traversal is used for pre-authorization (e.g., of a total amount) and another type of traversal for settlement advice requests (e.g., for partial amounts). Thus, each portion of the total amount associated with the corresponding settlement advice requests maybe be transferred individually without authorization using the CAV. The CAV may be authenticated during the authorization/pre-authorization phase, but the CAV need not traverse the network again. Instead, the unique data element is included in the processing requests for authorization purposes.

Existing client-server transaction network technologies also employ functionality that requires users to manually input CAV information for each transaction, which can be tedious. For example, for each CAV transaction a user engages in, the user has to manually enter the CAV information (e.g., at a terminal processing device or via a web page of a client device). However, if a merchant ever wanted to only charge a portion of a total amount (e.g., because the portions are shipped at different times), this would require tedious manual re-entry of the CAV by the user, which would require re-locating the user for each portion charged.

Particular embodiments improve these client-server transaction technologies by automating tasks (e.g., automatically processing a portion of a pre-authorized total amount with a unique data element) via certain rules (e.g., there are matching unique data elements). As described above, such tasks are not automated in various existing technologies and have only been historically performed by manual computer input by humans. As described above, typical client-server transaction networks require users to manually enter in CAV information on a terminal processing device or client application each time an amount is requested. In particular embodiments, incorporating these certain rules improve existing technological processes by allowing the automation of these certain tasks. For example, using the illustration above, if a merchant wanted to charge a partial amount of the total amount, instead of locating the user and requiring the user to manually input the CAV again, these improved networks can automatically request a portion of a total amount based on a pre-authorization of the total amount (e.g., a rule for the automation) and the automation can continue throughout the network, such as the UDE processing device 130 determining whether two UDEs match ,the verifying device 140 authorizing the total amount, and the actual transfer of the portion back to the merchant. In this way, the user need not manually re-enter the CAV because the CAV is not needed after preauthorization.

Particular embodiments also improve these client-server transaction technologies by providing more robust security than existing technologies. Instead of communicating a CAV multiple times, a single pre-authorization request is made for a total amount, which includes encrypting/decrypting the CAV when it is sent the first time. Then a unique data element is generated and used for authorization for individual or proportional amounts. In various embodiments the unique data element does not contain a CAV (e.g., a PIN number) and therefore, a user cannot perform brute force methods to identify the stored CAV. Further, because the CAV is not communicated multiple times over the network, there are no security risks for data sniffing or eves dropping. In some embodiments, the unique data element includes a new data structure or component that adds further improved security. For example, the unique data element can be packaged in a secure data container or wrapper that protects its contents from being sniffed or read.

In existing client-server transaction networks, CAV information often has to traverse over the network several times before a transaction is completed. However, this causes various computing resources to be unnecessarily consumed. For example, repetitive communication of the CAV based on manual data entry in these systems causes an increase in network traffic exchange and increased bandwidth utilization. This is due in part because there is overhead each time a processor populates header information in network protocol packets (e.g., TCP/IP) and performs handshaking (e.g., SYN, SYN-ACK, ACK) to communicate CAV information to various network servers. Thus, for each time slice, there are less bits available that can be transmitted over these networks for other tasks because the network is busy communicating CAV information. Moreover, there is an increase in storage device I/O (e.g., excess physical read/write head movements on non-volatile disk). Each time a user manually inputs CAV information, the computing system has to traverse the network and reach out to a storage device to perform a write and then a read operation. Accordingly, when this occurs multiple times, storage device I/O increases and eventually wears on components, such as a read/write head. Reaching out to disk multiple times is also very expensive because of the address location identification time and mechanical movements required of a read/write head for each I/O operation.

Embodiments also improve these client-server transaction technologies by reducing computing resource consumption. For example, because a CAV does not have to be communicated multiple times, network traffic exchange and bandwidth utilization is reduced. In an illustrative example, in existing client-server transaction technologies, for each transaction using a CAV, a consumer must log into a website or input information on a keypad of a card reader to perform a transaction. Each time the user enters in this information, packets of data are populated with header information, then a handshake is performed with the device communicated with (e.g., between the client device 105 and the acquisition device 120), which is an overhead. However, embodiments described herein improve this be removing the header and handshake steps at the second network traversal phase via automation, which reduces network utilization and disk I/O. For example, after a total amount has been preauthorized via a first phase of a network traversal, requests for portions of the total amount can be automated, which means that there is no needed communication of the CAV from a device of the user (which would otherwise be needed in the existing technology). This means that there is no network protocol communication between a user device (e.g., a client device, such as a mobile phone) and an acquisition device. Accordingly, there would be no header formation of packets and handshake (requiring SYN, SYN-ACK, and ACK) steps. Therefore, there would be less overhead and reduced traffic exchange, thereby freeing up bits to be transferred on the entire network for any given time slice for bandwidth purposes. This also means that there would be no repeated disk writes of the CAV between the terminal processing device or user device and the acquisition device, thereby reducing storage device I/O.

Traditional Personal Identification Number (“PIN”)-based debit transactions are limited to a single message that authenticates and initiates movement of funds when processing a transaction between consumer computing devices and merchant computing devices. For example, using conventional PIN-based debit card transactions, after reading a debit card and receiving a PIN from the debit cardholder, a single message may be generated to request the funds transfer. The single message includes a request to transfer an amount of funds from the debit card account. Upon approval, the approved amount of funds is transferred with no further messaging capabilities and the PIN is deleted for security purposes. Thus, upon approval, the approved amount of funds is transferred and the transaction is closed. As such, conventional PIN-based payments require manual PIN entry each time a transfer of funds is requested, transfers the entire approved amount upon approval, and offers little flexibility such as partial transfers of the approved amount as described above.

Single messaging capabilities are problematic in a number of contexts. For example, using a PIN-based debit card, a computing device located in a restaurant may be unable to pre-authorize an amount greater than the dining bill in order to account for potential tips. This is because conventional PIN-based single message transactions would cause the entire pre-authorization amount to be transferred upon approval. In another context, a computing device associated with an online retailer cannot pre-authorize a total amount due for a sale transaction having multiple items that may ship separately and incrementally charge their customer only after each item ships because the total amount due would have been transferred upon approval.

According to various implementations of the invention, various systems and methods may address these and other drawbacks of existing systems. According to various implementations of the invention, various systems and methods may process funds transfers by incorporating a consumer authentication value (CAV), such as cardholder PIN (personal identification number) or other consumer-specific secret information. The systems and methods may process the funds transfers by receiving a first authorization request comprising an encrypted CAV and a total amount of funds to be transferred. For example, the first authorization request may have originated from a merchant device that received a PIN and communicated a request to authorize a total amount. A second authorization request associated with the merchant originated first request may be generated and communicated to a verifying device, for example, that issued the payment card associated with the PIN. The second authorization request may include the encrypted CAV and the total amount of funds to be transferred. An authorization approval response may be received (from the verifying device 140, for example) that indicates that the total amount of funds to be transferred is authorized. A unique data element that is uniquely associated with the authorization approval response may be generated. In some implementations, the unique data element may include an alphanumeric string, a digital certificate, a binary file, and/or other data that can uniquely identify an authorization. In some implementations, the unique data element indicates that the total amount has been authorized. The unique data element may be communicated to, for example, a merchant terminal. The terminal processing device may use the unique data element to generate one or more settlement advice request messages that each request a transfer of a portion of the total pre-authorized amount.

The one or more settlement advice request messages, which may include the unique data element and a request to transfer a portion of the total amount, may be received. In some implementations, a determination may be made regarding whether the unique data element included in the settlement advice request message(s) matches the unique data element included in the first authorization approval response. In these implementations, in response to a match, transferring the portion of the total amount may be initiated without authorization with the CAV, which causes the CAV to be minimally communicated over the network. In other words, in some implementations, the CAV is used only to pre-authorize a total amount. The pre-authorization does not cause transfer of funds but instead may cause a hold on the funds. In these implementations, the unique data element, which does not include the CAV, is used to authenticate subsequent settlement advice request messages that actually cause portions less than (but not collectively greater than) the total pre-authorized amount to be transferred.

Thus, dual-phase network traversal and corresponding request messages may be generated for portions of the total amount. Each portion of the total amount associated with the corresponding settlement advice request(s) may be transferred individually without authorization using the CAV, which improves security and resource consumption as describe above. In other words, the CAV may be authenticated during the authorization/pre-authorization phase. Thereafter, the CAV (which includes sensitive information) need not be communicated again when the settlement(s) advice requests are initiated, communicated, and processed. Instead, the unique data element is included in the settlement advice(s) for authorization purposes.

According to various implementations of the invention, these improved client-server transaction networks may utilize dual-phase network traversal, which includes a dual-message transaction with separate authorization and settlement messages for consumer authentication value (CAV) based transactions. Example transactions using a CAV-authenticated authorization and separate settlement advice request messages may include, but not be limited to, purchase transactions, partial fulfillment transactions, cash advance transactions, bill pay transactions, recurring payments transactions, consumer funding transactions, business funding transactions, business payment transactions, consumer payment transactions, travel and entertainment payment transactions, and/or other payment transactions that use a CAV to authenticate a pre-authorization amount that is not transferred until a subsequent settlement advice request message that does not use the CAV is received.

A consumer may include a person or other entity that requests goods and/or services from a merchant (used interchangeably with “payee”), is a cardholder, or otherwise wishes to transfer funds from an account of the consumer to another account. A merchant may include a person or other entity that requests a funds transfer (for example, a payment) associated with the goods and/or services and renders the goods and/or services to the consumer, or otherwise wishes to receive a transfer of funds from the consumer. A financial institution may include a bank such as a payment card issuing bank or other entity that provides the requested funds to the merchant.

A consumer authentication value (CAV) may include data kept private by the consumer or cardholder. In some implementations, the CAV may include a PIN (personal identification number) or other data such as an alphanumeric password, digital certificate, etc. In some implementations, the CAV need not be dependent on the attributes physically encoded or embossed on a card/device (for example, credit card, debit card, etc.), nor on any dynamic value generated as part of the transaction by a chip or a computer.

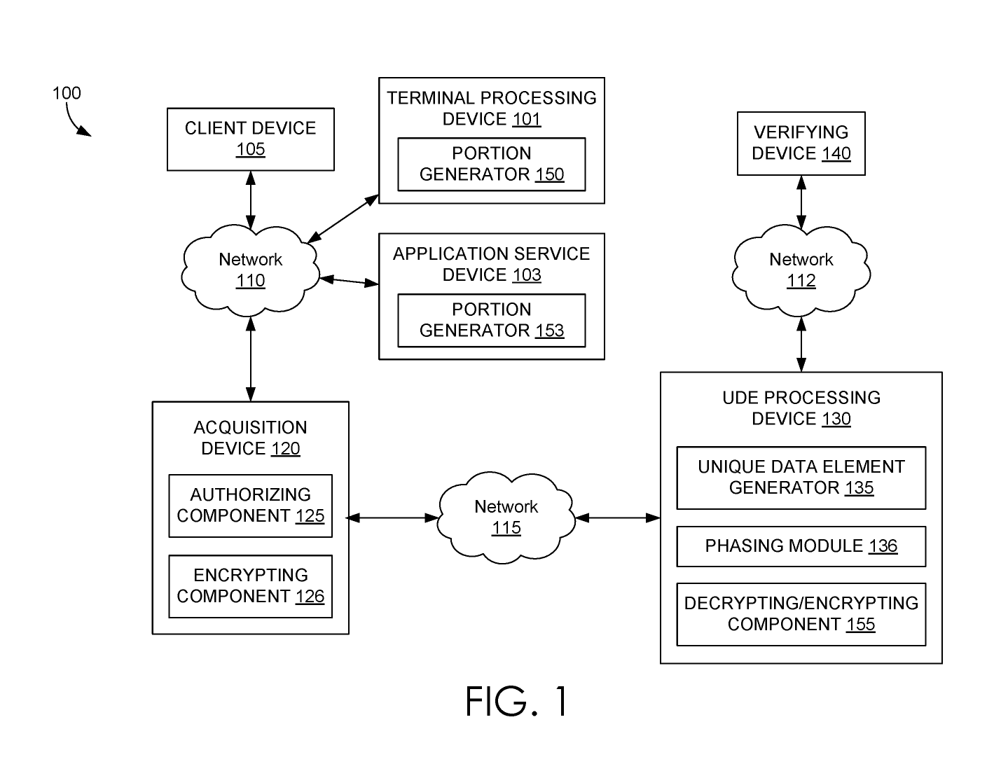

FIG. 1 is a block diagram illustrating an example of a system 100 that depicts an improved client-server transaction network for processing funds transfers according to various implementations of the invention. System 100 may include, for example, a terminal processing device 101, an application service device 103, a client device 105, an acquisition device 120, a network 110, a network 115, a network 112, a UDE processing device, and a verifying device 140. Although the system 100 is depicted as including the networks 110, 115, and 140, it is understood that in some embodiments, each of these networks together form a larger client-server transaction network. In various aspects, when one portions of this overall network is affected (e.g., in terms of network traffic exchange, security, etc.) the entire network is affected.

FIG. 1 includes at least four special-purpose computers, which includes the UDE processing device 130, the terminal processing device 101, the application service device 103, and the acquisition device 120 by nature of their components as illustrated in FIG. 1. For example, the UDE processing device 130 includes three special-purpose components—the unique data element generator 135, the phasing module 136, and the decrypting/encrypting component 140. The unique data element generator 135 generates a unique data element (e.g., a new data structure) that in various embodiments includes a pre-authorization approval indicator for a total amount, a pre-defined secret, a private key, and/or can be uniquely be included in a wrapper or container for security purposes. The phasing module 136 generates new automated functionality for flexibly traversing the network, which can consume less computing resources. Specifically, the phasing module 136 can generate a first phase communication to the verifying device 140 for a pre-authorized total amount, which is not functionality that existing client-server transaction networks currently employ. This new functionality allows computers to be able to make automated transaction requests (which does not require manual re-entry of the CAV) on portions of the overall amount because the overall amount has been pre-authorized. The phasing module 136 can additionally generate a second phase (or set of phases) communication by first determining whether there is a unique data element match between the version the UDE processing device stores and an incoming version from a merchant device based on the merchant device requesting a portion of the pre-authorized total amount (e.g., via the authorizing component 125). The phasing module 136 can then communicate an indication of the match to a verification server. The decrypting/encrypting component 140 both decrypts an encrypted CAV (e.g., generated by the encrypting component 126 of the acquisition device) during pre-authorization and encrypts the CAV when sending to the verifying device 140, which enhances security. In some embodiments, the unique data element can also be encrypted and/or decrypted.

The terminal processing device 101 and the application service device 103 each respectively include the portion generator 150 and 153. These components allows the application service device 103 and/or the terminal processing device 101 to generate a request for portion of a pre-authorized total amount along with a unique data element in response to receiving the unique data element from another entity (e.g., the acquisition device 120).

According to various implementations of the invention, a client device or terminal processing deice may request goods and/or services associated with a merchant or otherwise wish to transfer funds to these devices. In some implementations, a consumer may visit a brick-and-mortar location of the merchant. In these implementations, the consumer may present a payment card or other device used for payments, where terminal processing device 101 may be used to prompt for and receive the CAV and obtain account identification information (e.g., credit card number) from the payment card such as by swiping the card, using near-field technology, etc.

In some implementations, using client device 105 the consumer may visit an online “virtual” store of the merchant such as a merchant website, provided by an application service device 103. In these implementations, the consumer may input the financial account identification information and CAV using a key pad or other input mechanism of client device 105. According to various implementations of the invention, examples of client device 105 may include any one or more of, for instance, a personal computer, portable computer, personal digital assistant (PDA), workstation, web-enabled mobile telephone, WAP device, web-to-voice device, or other device. In other words, client device 105 may include a data (or Internet) function configured to communicate data via network 110.

In some implementations, the consumer may wish to provide a funds transfer to the merchant without buying goods/services. In these implementations, the merchant may include an individual, a charitable organization, or other entity to which the consumer would like to transfer funds and the payment may be handled by a third party (not illustrated in FIG. 1).

In some implementations, the terminal processing device 101, application service device 103, or third party may generate a request to process a total amount of funds to be transferred and the CAV. In some implementations, the request is communicated via network 110 to the acquisition device 120 for determining whether the total amount of funds is approved and for processing subsequent funds transfers associated with the authorization request. In some embodiments, the acquisition device 120 includes a merchant acquirer.

In some implementations of the invention, the acquisition device 120 may be associated with the merchant. In these implementations, the acquisition device 120 may request and receive, over the computer network 115, the funds transfer on behalf of the merchant. For example, acquisition device 120 may include a special-purpose computer system of an acquiring bank that interfaces with various payment networks, such as the UDE processing device 130, on behalf of the merchant in order to receive funds from the verifying device 140, which may be associated with an issuing bank of a payment card account or other financial account.

In response to the request from the terminal processing device 101 or client device 105 associated with the merchant or third party, the acquisition device 120 may communicate an authorization request to the UDE processing device 130. In some implementations, if the CAV is not already encrypted, the acquisition device 120 may encrypt the CAV prior to communicating the authorization request to enhance data security to guard against data sniffing, eves dropping, etc. The authorization request may include the encrypted CAV, a total amount of funds to be transferred, and/or other information associated with the request associated with the merchant.

According to various implementations of the invention, the UDE processing device 130 receives the authorization request. According to various implementations of the invention, the encrypted CAV received in the authorization request is authenticated by the UDE processing device 130. UDE processing device 130 may decrypt the CAV and determine whether the decrypted CAV is authentic via authentication techniques. In some implementations where the verifying device 140 authenticates the CAV, the UDE processing device 130 would only re-encrypt the CAV and traverse over the network 112 to the verifying device 140, which maintains robust security for attacks.

In response to a determination that the CAV is authentic, UDE processing device 130 may re- encrypt the CAV and include the encrypted CAV in a second authorization request to the verifying device 140. In some implementations, if the UDE processing device 130 validates the CAV, the CAV will not be re-encrypted and not be passed to the verifying device 140, which causes the CAV not to be sent more than is necessary for security purposes. In some implementations, the second authorization request may be a first phase of a dual-phase network traversal and include the encrypted CAV and the total amount of funds to be transferred. In some implementations, the second authorization request be a second phase of a dual-phase network traversal and may include a request to pre-authorize the total amount of funds and hold the funds (for example, hold the funds associated with total amount in the bank or other financial account of the consumer).

In some implementations, the verifying device 140 may determine the encrypted CAV included in the second authorization request is authentic. In response to a determination that the CAV is authentic, verifying device 140 may communicate an authorization approval response to UDE processing device 130, provided that the total amount can be transferred from the associated financial account. In some implementations, verifying device 140 does not transfer the total amount of funds but instead places a hold on the corresponding financial account.

According to various implementations of the invention, UDE processing device 130 may receive an authorization approval response that indicates that the total amount of funds to be transferred is authorized/approved. In some implementations, UDE processing device 130 may receive the authorization approval response from verifying device 140.

According to various implementations of the invention, in response to the authorization approval response, UDE processing device 130 may generate unique data element. The unique data element may comprise a pre-defined secret, private key or other attribute that is uniquely associated with the authorization approval response. In some implementations, the unique data element may provide an indication that the total amount has been authorized. In this manner, the unique data element may be used in subsequent communications with UDE processing device 130 to indicate approval of the total amount without another authorization process using the CAV, which improves security.

In some implementations, UDE processing device 130 may communicate to acquisition device 120 an indication that the total amount has been authorized. In some implementations, the indication may include the unique data element, the authorization approval response, and/or other indications that the total amount has been authorized.

In some implementations, acquisition device 120 may communicate the approval indication from the UDE processing device 130 to the terminal processing device 101, the application service device 103, and/or the third party computing device. In some implementations, the terminal processing device 101 and/or the application service device 103 retains the unique data element in order provide proof or indication that the total amount has already been authorized.

In some implementations, when the merchant wishes to receive a portion of the total amount that was pre-authorized, the terminal processing device 101 and/or the application service device 103 associated with the merchant may generate a request (e.g., via the portion generator 140) for one or more portions of the total amount to be transferred. Instead of providing a CAV for authentication, the terminal processing device 101 may provide the unique data element and the proportioned amount. For example, the terminal processing device 101 may communicate a request to acquisition device 120 to receive a funds transfer for a portion of the total amount, where the request includes an indication of the portion desired and the unique data element.

In this manner, the device(s) associated with the merchant may receive a portion of the pre-authorized total amount without having to again provide the CAV (which may no longer be possible because the consumer is no longer present). Providing the CAV again may also require additional manual entry of the CAV, which is tedious. In an illustrative example of these embodiments, the merchant may have a restaurant terminal device that used a consumer-provided CAV to pre-authorize a total amount of funds in the amount of $100 for a dinner bill of $70. After receiving an authorization approval and unique data element, the restaurant terminal device may request, without again having to use the CAV, a funds transfer of $85, which includes tip. The restaurant may also provide two separate subsequent requests, one for $70 and another for $15, both of which are portions of the total pre-authorized amount. In this example, two different funds transfers will occur without re-entering a CAV while both have been pre-authorized with the CAV. In this way, repeated manual entry by users is not needed to input the CAV. Rather, these client-server transaction networks automatically traverse the network in phases and request for each portion needed without manual user input. Similarly, in another example, an online retailer device associated with the merchant that pre-authorized a total amount but requests portions of the total amount as various items actually ship at different times.

According to various implementations of the invention, in response to the request(s) by the terminal processing device 101 and/or the application service device 103, acquisition device 120 may generate and communicate one or more settlement advice request messages to initiate movement of funds (i.e., movement of fund that were put on hold) from the verifying device 140 to the terminal processing device 101 and/or the application service device 103. In some implementations, the terminal processing device 101 and/or the application service device 103 may generate the settlement advice request message(s) and communicate the messages to acquisition device 120. In some implementations, acquisition device 120 may communicate the settlement advice request message(s) to UDE processing device 130. In these implementations, the settlement advice request message(s) may be received by UDE processing device 130.

According to various implementations of the invention, settlement advice request message(s) may be associated with the authorization approval response, wherein each settlement advice request message may include a request to transfer a portion of the authorized total amount indicated by the authorization approval response. In some implementations, each settlement advice request message may include the unique data element and the requested transfer amount.

According to various implementations of the invention, UDE processing device 130 may process each received settlement advice request message. UDE processing device 130 may retrieve the unique data element included in the settlement advice request message and compare it with the unique data element that was previously generated by UDE processing device 130 (i.e., the unique data element that was uniquely associated with the authorization approval response and that was previously communicated to acquisition device 120 by UDE processing device 130). In response to a match, UDE processing device 130 may determine that the settlement advice request message is associated with the second authorization request/authorization approval response. In other words, UDE processing device 130 may determine that the settlement advice is associated with the original authorization/pre-authorization. In response to a determination that there is no match, the advice request message will be denied and no transfer of funds will occur.

According to various implementations of the invention, UDE processing device 130 may communicate the settlement advice request message to the verifying device 140. In response, the verifying device 140 may debit the corresponding financial account and transfer (i.e., credit) the portion of the total amount associated with the settlement advice request message to acquisition device 120 without again authenticating the CAV. Thereafter, in some implementations, acquisition device 120 may cause the portion of funds to be transferred to the terminal processing device 101 and/or the application service device 103. For example, acquisition device 120 may cause the portion of funds to be transferred to an account of one of these merchant devices, which may be serviced by acquisition device 120 or other entity/financial institution computing device.

According to various implementations of the invention, the CAV is authenticated and communicated during the initial authorization/pre-authorization for a specified total amount. Subsequently, the unique data element(s) generated by the UDE processing device 130 and included in the settlement advice request message(s) are used for purposes of authorizing the movement of funds between the verifying device 140 and the terminal processing device 101 and/or the application service device 103. Thus, sensitive information (e.g., the CAV) need not be communicated again between the various entities for settlement of transactions (e.g., consumer, payee/acquisition device 120, UDE processing device 130, and verifying device 140). Not only does this provide enhanced security, but also allows the terminal processing device 101 and/or application service device 103 to receive the CAV from the client device 105 (and/or the terminal processing device 101) once for a particular transaction and receive subsequent payments (i.e., funds transfers) that can be portions of the total amount associated with the particular transaction without the consumer being present or otherwise again inputting the CAV. This reduces the amount of manual data entry needed from users because the system automates authorization for the particular amounts without needing user input multiple times.

In some implementations, UDE processing device 130 may associate settlement advice request messages with the unique data element and total amount that was pre-authorized in order to determine whether a sum of the portions requested in the settlement advice request messages exceeds the total amount that was pre-authorized. In some implementations, UDE processing device 130 may initiate a funds transfer when the portion requested by a settlement advice request message, when summed with prior settlement advice request messages associated with the unique data element, does not exceed the total amount. In some implementations, UDE processing device 130 may perform exception handling when a portion to be transferred when summed with other portions already transferred exceeds the total amount that was pre-authorized. The UDE processing device 130 may approve or decline such settlement advice requests based on network processing rules between the merchant and UDE processing device 130 and between UDE processing device 130 and verifying device 140.

By providing separate dual-phase network traversal via authorization requests and settlement advice request messages, CAV-based transactions may be facilitated at any merchant site (e.g., ecommerce or “brick-and-mortar”). Funds availability may be guaranteed to the merchant before goods and services are rendered. Thereafter, computing devices (e.g., the client device 105 and/or the terminal processing device 1010) may initiate one or more settlement advice request messages associated with the authorization/pre-authorization as goods and/or services are rendered. As will be referenced herein, any references to a request, response, authorization, declination, approval, or other communication between various components described in various embodiments of the present disclosure can be a data structure, data packet, message, transaction, or other electronic or digital message and/or signal that is generated by one of the components. Moreover, any of the foregoing can be sent (e.g., communicated) from the generating component via a network to another one of the various components described herein. In this regard, the communication can cause another operation or feature to be invoked by a receiving one of the components in accordance with various embodiments of the present disclosure.

According to various implementations of the invention, acquisition device 120, UDE processing device 130, and/or verifying device 140 may encrypt the CAV. In some implementations, a Triple Data Encryption Algorithm (commonly, “Triple DES”) may be applied to encrypt/decrypt the CAV. As would be appreciated by those having skill in the art, other encryption algorithms may be utilized.

In some implementations, a database (not illustrated in FIG. 1) may include consumer information, such as, for example, credit card numbers, debit card numbers, consumer contact information, an identity of communication device 105 used by the consumer, and/or other information. In some implementations, the database may store the transaction related data elements including the unique data element for later retrieval by acquisition device 120, UDE processing device 130, and/or verifying device 140. According to various implementations of the invention, examples of the database, include, for instance, a relational database, a file system, and/or other device or data representation configured for data storage.

In various embodiments, the UDE processing device 130 is a special purpose computer, such as an EFT server. Accordingly, computing device 130 may perform EFT transactions involving funds transfer via EFT messages. The EFT messages could be in the form of ISO 8583 payment messages supported by various EFT networks. Each network adapts the ISO 8583 standard for its own use with custom fields and custom usages. The placement of fields in different versions such as 1987, 1993 and 2003 of the standard varies. Also, one EFT network may act as a gateway to other EFT networks to provide universal coverage.

In some implementations, UDE processing device 130 receives the consumer's bank account information from the verifying device 140. In some implementations, UDE processing device 130 acquires the payee's account information from acquisition device 120. In some implementations, the database may include the payee's account information and UDE processing device 130 may retrieve the payee's account information from the database.

In some implementations, UDE processing device 130 debits the portion of the total amount from the consumer's bank account. In some implementations, UDE processing device 130 credits the portion of the total amount to the payee's account.

In some implementations, UDE processing device 130 generates a receipt for the consumer and the payee. The receipt may include, among other information, an amount of fund transfer (i.e., portion of total amount credited to payee account or debited from consumer account), date the transfer was credited/debited, the type of transfer and type of account (i.e., checking, savings, or other account) to which funds were transferred, the name of payee to whom funds were transferred, or the name of consumer from whom funds were transferred, consumer/payee account number, and/or any fees assessed against the consumer/payee account for the fund transfer. In some implementations, UDE processing device 130 may communicate the receipt to client device 105 or acquisition device 120 via email, text messages, or other communication mechanisms. The consumer may view the receipt via client device 105.

According to various implementations of the invention, acquisition device 120 may communicate with client device 105 on a communication channel via network 110. Acquisition device 120 may communicate with UDE processing device 130 on a communication channel via network 115. UDE processing device 130 may communicate with verifying device 140 on a communication channel via network 112. Network 110, 112, or 115 may be a Public Switch Telephone Network (PSTN), VOIP network, and/or other network or combination of networks that is configured for electronic communications (voice and data).

In some implementations, acquisition device 120 may include one or more of a: processor, a memory device, and/or other components that facilitate the functions of acquisition device 120. In some implementations, the processor includes one or more processors configured to perform various functions of acquisition device 120. In some implementations, the memory device includes one or more tangible (i.e., non-transitory) computer readable media. The memory device(s) may include one or more instructions that when executed by processor configure processor to perform functions of acquisition device 120. In some implementations, a memory device may include one or more instructions stored on tangible computer readable media that when executed at a remote device, such as client device 105, or UDE processing device 130 cause the remote device to facilitate interaction with payee processing server, as described herein.

In some implementations, UDE processing device 130 may also include a processor, a memory device, and/or other components that facilitate the functions of UDE processing device 130. In some implementations, the processor includes one or more processors configured to perform various functions of UDE processing device 130. In some implementations, the memory device includes one or more tangible (i.e., non-transitory) computer readable media.

### Memory

The memory device may include one or more instructions that when executed by the processor configure the processor to perform functions of UDE processing device 130. In some implementations, the memory device may include one or more instructions stored on tangible computer readable media that when executed at a remote device, such as acquisition device 120 or a device associated with financial institution, cause the remote device to facilitate interaction with the UDE processing device 130, as described herein.

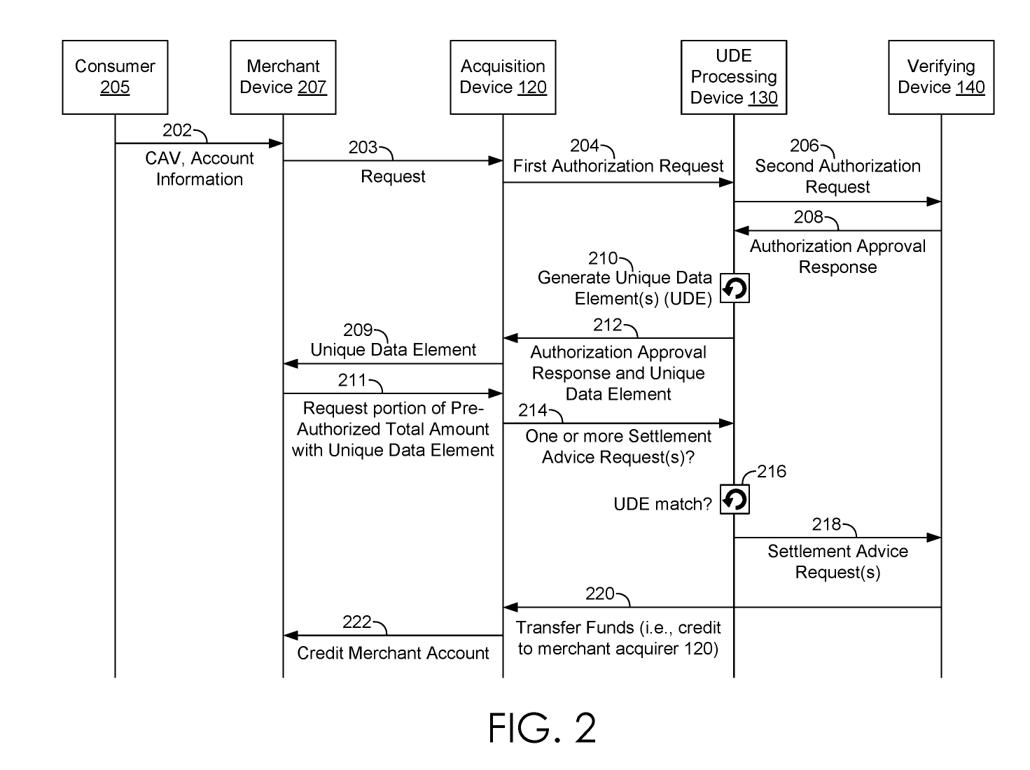

FIG. 2 is a data flow diagram illustrating exemplary process relationships in a system for network traversal in client-server transaction systems, according to various implementations of the invention. Consumer 205 may wish to transfer funds to merchant device 207 and may therefore provide account information and a CAV in operation 202. For example, consumer 205 may purchase goods/services from a merchant or may wish to simply transfer funds to merchant device 207. In order to cause the funds to be transferred, consumer 205 may provide account information such as a payment card number and input the CAV into a keypad (e.g., the terminal processing device 101). In some implementations, consumer 205 may request goods/services via a website associated with merchant device 207 (e.g., the application service device 103). In some implementations, consumer 205 may request goods/services at a brick-and-mortar location of the merchant.

In some implementations, merchant device 207 generates a request to acquisition device 120 in an operation 203. For example, a terminal processing device (such as a card reader) 207 may communicate the account information, CAV, and amount to transfer to acquisition device 120. In some implementations, acquisition device 120 may receive the consumer request via a client device of the consumer (such as client device 105 illustrated in FIG. 1). In these implementations, consumer 205 may use client device 105 to navigate an e-commerce website of a merchant associated with the merchant device 207. In some implementations, consumer 205 may utilize client device 105 to provide a CAV associated with the consumer.

In some implementations, consumer 205 may visit a payee store (e.g., a brick and mortar retail establishment associated with the payee) to request goods/services. In some implementations, consumer 205 may swipe or otherwise cause a payment card to be read at the store. In some implementations, consumer 205 may input card/account information, CAV, and/or other information in a different manner at the store such as by manually inputting the information into a keypad, using near-field devices, or using a smart chip. In some implementations, the merchant may utilize acquisition device 120 to process the consumer request.

According to various implementations of the invention, acquisition device 120 may generate a first authorization request (e.g., via the pre-authorizing component 125) in preparation for a first phase network traversal and communicate the first authorization request to UDE processing device 130 in operation 204. In some implementations, acquisition device 120 may encrypt the CAV (e.g., via the encrypting component 126) obtained from the client device 105, the terminal processing device 101, and/or the application service device 103 and include the encrypted CAV in the first authorization request for more robust security. In some implementations, the first authorization request may include, among other things, a transaction identifier, the encrypted CAV, and the total amount of funds to be transferred based on the total payment amount associated with the consumer request.

According to various implementations of the invention, UDE processing device 130 may generate a first phase network traversal (e.g., via the phasing module 136), which includes a second authorization request based on the received first authorization request in operation 206. UDE processing device 130 may continue the first phase network traversal, which includes communicating the second authorization request to the verifying device 140.

In some implementations, UDE processing device 130 may retrieve the encrypted CAV from the first authorization request. UDE processing device 130 may decrypt (e.g., via the decrypting/encrypting component 140) the CAV and determine whether the decrypted CAV is authentic. In response to a determination that the CAV is authentic, UDE processing device 130 may generate a second phase traversal (e.g., via the phasing module 136) over the network, which includes the second authorization request. In some embodiments, UDE processing device 130 may encrypt the CAV (e.g., via the decrypting/encrypting component 140) and include the encrypted CAV in the second authorization request, which provides robust security while the CAV is being communicated to different entities. In some implementations, the second authorization request may include, among other things, the encrypted CAV, the total amount of funds to be transferred (from the first authorization request 204), and the transaction identifier. In some implementations, in response to a determination that the CAV is not authentic, the first authorization request message will be denied.

According to various implementations of the invention, verifying device 140 may generate an authorization approval response based on the second authorization request and communicate the authorization approval response back to UDE processing device 130 in operation 208. In some implementations, the authorization approval response may indicate that the total amount of funds to be transferred is authorized, which completes the first phase network traversal.

In some implementations, the verifying device 140 may retrieve the encrypted CAV from the second authorization request. The verifying device 140 may decrypt the CAV and determine whether the decrypted CAV is authentic. In response to a determination that the CAV is authentic, verifying device 140 may determine whether the bank account associated with the consumer has sufficient funds to cover the total amount included in the second authorization request. In response to a determination that the bank account has sufficient funds, the verifying device 140 may generate the authorization approval response, which indicates that the total amount of funds to be transferred is authorized, and may put a hold on the authorized funds. This functionality is not performed on existing client-server transactions. In response to a determination that the bank account does not have sufficient funds, verifying device 140 may decline the request and communicate a message to that effect.

In some implementations, the authorization approval response from verifying device 140 may include, among other things, the transaction identifier and the authorized total amount of funds to be transferred.

In some implementations, in response to the authorization approval response received from verifying device 140, UDE processing device 130 may generate unique data element (e.g., via the unique data element generator 135) that is uniquely associated with the received authorization approval response in operation 210. In some implementations, the unique data element may include a pre-defined secret, a private key, or other unique attribute. In some embodiments, the unique data element does not include a CAV and is packaged in a container or security wrapper so that the communication of the unique data element cannot be spoofed or otherwise compromised. A security wrapper in the context of the present disclosure monitors and filters all incoming requests for the unique data element. Effectively, the security wrapper is data (e.g., a header and/or trailer) that encapsulates the unique data element from view to anyone other than the intended recipient.

In some implementations, the unique data element and the authorization approval response is communicated by UDE processing device 130 to acquisition device 120 in operation 212. In some implementations, the unique data element provides an indication that the total amount of funds to be transferred has been authorized.

In some implementations, acquisition device 120 may communicate the unique data element to merchant device 207 in operation 209. In operation 209, merchant device 207 is notified of the pre-authorization of the total amount of funds.

In some implementations, merchant device 207 may, after receiving the pre-authorization indication, request to have transferred a portion of the pre-authorized total amount in an operation 211 (e.g., via the portion generator 150 and/or 153). For example, the merchant may ship out a portion of a purchase and wish to be paid for that portion. In this example, the remaining purchase may have yet to ship and as a service the merchant may not wish to receive funds from consumer 205 until the remaining purchase items are shipped. In operation 211, the merchant device 207 may provide the portion of funds to be transferred and the unique data element as proof that the portion should be authorized based on the authorized approval identified by the unique data element. In some implementations, the request is in the form of a settlement advice request message, which indicates the portion to be transferred and includes the unique data element. Notably, this does not require manual re-entry of the CAV, such as human input on a client device, which is an improvement over existing technologies because step 211 can be performed automatically without user input. This removes network communication between a client device (e.g., the client device 105) and the merchant device 207 (e.g., application service device 103), thereby reducing bandwidth utilization for the entire network, including the UDE server computing device 130, as described above.

According to various implementations of the invention, in response to the merchant request, acquisition device 120 may generate and/or communicate a settlement advice request message to 130 in operation 214. Each settlement advice may include, among other things, the transaction identifier, the unique data element that was communicated to the acquisition device 120 by UDE processing device 130, and a request to transfer a portion of the total amount of funds to be transferred.

In some implementations, UDE processing device 130 may identify the authorization request(s), or authorization approval response that each settlement advice request is associated with based on the transaction identifier. In other words, UDE processing device 130 may determine whether the settlement advice request has a corresponding authorization request or authorization approval response based on the transaction identifier. In response to a determination that the settlement advice request(s) does have a corresponding authorization request or authorization approval response, UDE processing device 130 may compare (in operation 216) (e.g., via the phasing module 136) the unique data element included in the settlement advice request(s) with the unique data element previously generated by the UDE processing device 130 (i.e., the unique data element that was uniquely associated with the authorization approval response and that was communicated to acquisition device 120 by UDE processing device 130). In response to a match, UDE processing device 130 may communicate (e.g., via the phasing module 136) the settlement advice request to verifying device 140 (in operation 218) to initiate movement of funds from the verifying device 140 to acquisition device 120.

In response to a determination that there is no match, UDE processing device 130 may provide an exception message (e.g., via the phasing module 136) to acquisition device 120 that the unique data element provided is not associated with a corresponding pre-authorized approval amount.

According to various implementations of the invention, in operation 220, verifying device 140 may process the settlement advice request and initiate a transfer of the associated portion of the total amount to acquisition device 120 without authorization with the CAV. In some implementations, acquisition device 120 may render transfer of the associated portion to merchant device 207 such as by causing a credit to an account of merchant device 207 in an operation 222.

For example, acquisition device 120 may generate a first authorization request including an encrypted CAV and a total amount of 100 dollars to be transferred. Acquisition device 120 may communicate the first authorization request to UDE processing device 130. UDE processing device 130 may generate a first network phase traversal that includes a second authorization request associated with the first authorization request. The second authorization request may include the encrypted CAV and the total amount of 100 dollars to be transferred. Verifying device 140 may receive the second authorization request and may determine that the consumer's bank account has sufficient funds to cover the total amount of 100 dollars. Verifying device 140 may generate and communicate an authorization approval response to the UDE processing device 130 indicating that the total amount of 100 dollars is authorized. UDE processing device 130 may communicate the approval response/unique data element to acquisition device 120.

Subsequently, acquisition device 120 may generate a first settlement advice request comprising the unique data element and a request to transfer a first amount of the total amount (for example, 50 dollars of the 100 dollars—based on a first portion of the goods/services to be/being rendered to the consumer). UDE processing device 130 may receive the first settlement advice request and continue with a second phase network traversal by first determining whether the unique data element included in the advice matches the unique data element included in the approved authorization response. In response to a match, UDE processing device 130 may communicate the first settlement advice request to the verifying device 140 to initiate the transfer of the first amount without CAV authentication. Verifying device 140 may transfer the first amount from the consumer's bank account (i.e., the funds there were put on hold in the consumer's bank account) to the payee.

Thereafter, acquisition device 120 may generate a second settlement advice request comprising the unique data element and a request to transfer a second amount of the total amount (for example, the other 50 dollars of the 100 dollars—based on a second portion of the goods/services to be/being rendered to the consumer). UDE processing device 130 may further continue with the second phase network traversal by receiving the second settlement advice request and determine whether the unique data element included in the advice matches the unique data element included in the approved authorization response. In response to a match, UDE processing device 130 may communicate the second settlement advice request to the verifying device 140 to initiate the transfer of the second amount without authorization with the CAV. Verifying device 140 can calculate a sum of the first amount and the second amount, compare it to the total amount, to make a determination that the sum does not exceed the total amount. Verifying device 140 may transfer the second amount from the consumer's bank account (i.e., the funds there were put on hold in the consumer's bank account) to a computing device associated with the payee (e.g., the application service device 103) provided that the sum is determined not to exceed the total amount.

In some implementations, UDE processing device 130 may perform a calculation to determine whether a sum of the first amount and the second amount is greater than the total amount prior to communicating the settlement advice request to the verifying device 140. For example, the first settlement advice request may include a first amount of 50 dollars and the second settlement advice request may include a second amount of 60 dollars, totaling to 110 dollars which is greater than the authorized 100 dollars. In response to a determination that the sum is greater than the total amount, the UDE processing device 130 may decline (or approve, provided alternatively defined rules) such settlement advice requests based on EFT network processing rules between the merchant device 207 and UDE processing device 130 and between UDE processing device 130 and verifying device 140.

In some implementations, UDE processing device 130 may determine whether a sum of the first amount and the second amount is lesser than or equal to the total amount prior to communicating the settlement advice request to the verifying device 140. For example, the first settlement advice request may include a first amount of 50 dollars and the second settlement advice request may include a second amount of 40 dollars, totaling to 90 dollars which is lesser than the authorized 100 dollars. In response to a determination that the sum is lesser than or equal to the total amount, the UDE processing device 130 may eventually expire any pre-authorized funds based on EFT Network processing rules.

In some implementations, for certain payment transactions, for example, travel and entertainment payment transactions, the sum of the first amount and the second amount may exceed the total amount by a variable percentage, which may be configurable or otherwise predefined. In these implementations, UDE processing device 130 may determine whether the sum of the first amount and the second amount is greater than the total amount in addition to the variable percentage. In response to a determination that the sum is greater than the total amount, the UDE processing device 130 may approve or decline such settlement advice requests based on EFT network processing rules between the merchant device 207 and UDE processing device 130 and between the UDE processing device 130 and the verifying device FI140. In these implementations, UDE processing device 130 may determine whether the sum of the first amount and the second amount is lesser than the total amount in addition to the variable percentage. In response to a determination that the sum is lesser than the total amount, UDE processing device 130 may approve the transaction.

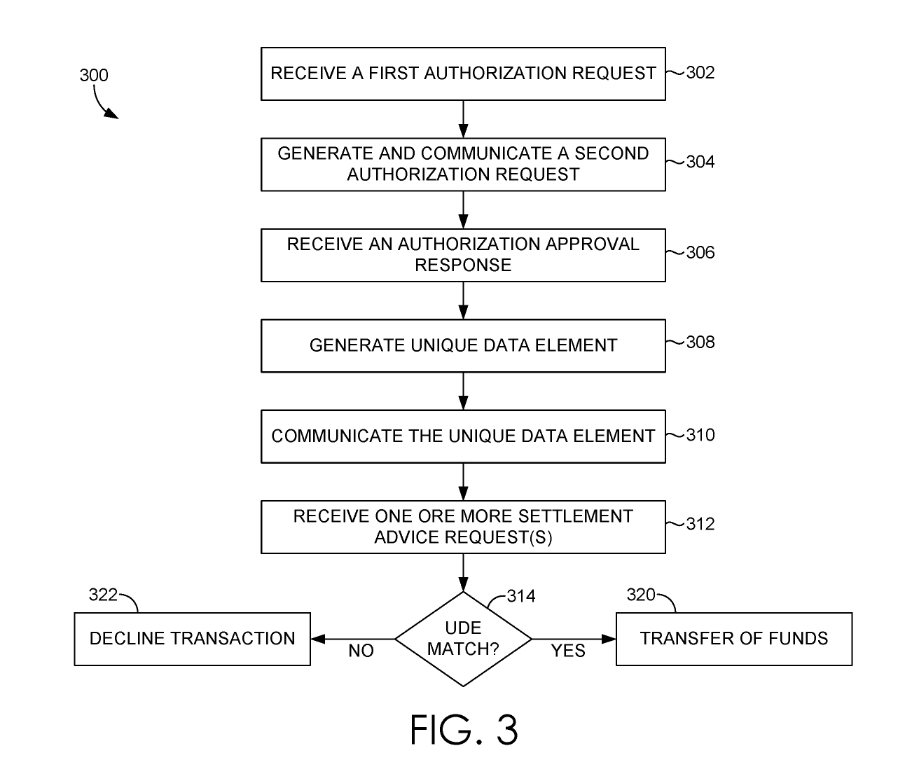

FIG. 3 is a flow diagram illustrating an example process 300 of processing electronic funds transfers according to various implementations of the invention. The various processing operations depicted in the flow diagram of FIG. 3 (and in the other drawing figures) are described in greater detail herein. The described operations for a flow diagram may be accomplished using some or all of the system components described in detail above and, in some implementations, various operations may be performed in different sequences. In some implementations, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting. According to various implementations of the invention, in an operation 302, process 300 may receive a first authorization request. In some implementations, the authorization request may include an encrypted CAV and a total amount of funds to be transferred.

In an operation 304, process 300 may generate (e.g., via the phasing module 136) and communicate a second authorization request associated with the received first authorization request. In some implementations, the second authorization request may include the encrypted CAV and the total amount of funds to be transferred.

In an operation 306, process 300 may receive an authorization approval response that indicates that the total amount of funds to be transferred is authorized. In an operation 308, operation 300 may generate a unique data element (e.g., via the unique data element generator 135). In some implementations, the unique data element may include a private key, a pre-defined secret, or other unique attribute.

In an operation 310, process 300 may communicate the unique data element. In an operation 312, process 300 may receive one or more settlement advice request messages. In some implementations, each settlement advice request message may include the unique data element and a request to transfer a portion of the total amount.

In an operation 314, process 300 may determine (e.g., via the phasing module 136) whether the unique data element included in the settlement advice request matches the unique data element included in the approved authorization response.

In an operation 320, in response to a match, process 300 may cause a transfer of the portion of the total amount without authorization with the CAV. In an operation 322, in response to no match, process 300 may deny the transaction indicating that no match was found.

The description above applies to processing of funds transfers for payment transactions, including purchase transactions, partial fulfillment transactions, consumer and business payment transactions. The description applies to other types of transactions as well such as a consumer wishing to transfer funds to another person or entity. For example, for bill pay and recurring payment transactions, UDE processing device 130 may generate and communicate an authorization request to verifying device 140. The authorization request may be generated when a bill is to be paid by a consumer to the payee. The authorization request may be effective for a pre-determined time period. The authorization request may include an encrypted CAV associated with the consumer payee information and/or other information. The verifying device 140 may authenticate the CAV to determine consumer authenticity. The verifying device 140 may generate an authorization approval response that indicates that the consumer has been authenticated. UDE processing device 130 may generate at least one unique element that is uniquely associated with the authorization approval response and that provides proof that the consumer has been authenticated.

UDE processing device 130 may receive one or more subsequent bill pay/recurring payment financial requests. Each bill pay/recurring payment financial request may include the unique data element, payee information and a requested amount (i.e., a request to transfer a payment amount). UDE processing device 130 may determine whether the unique data element included in the bill pay/recurring payment financial request matches the unique data element included in the approved authorization response.

In response to a match, UDE processing device 130 may determine whether the pre-determined time period for which the authorization request is effective has expired. In response to a determination that the pre-determined time period has not expired, UDE processing device 130 generates and sends a financial request to verifying device 140 for authorization. In response to a determination that the financial request was approved by verifying device 140, based on consumer funds availability at the time of the financial request, UDE processing device 130 causes transfer of the amount requested in the financial request without authorization with the CAV.

A “module,” “component,” and “generator,” as described herein is any set of hardware, firmware, and/or software that operatively works to perform a function, without regard to whether the module/component/generator is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication.

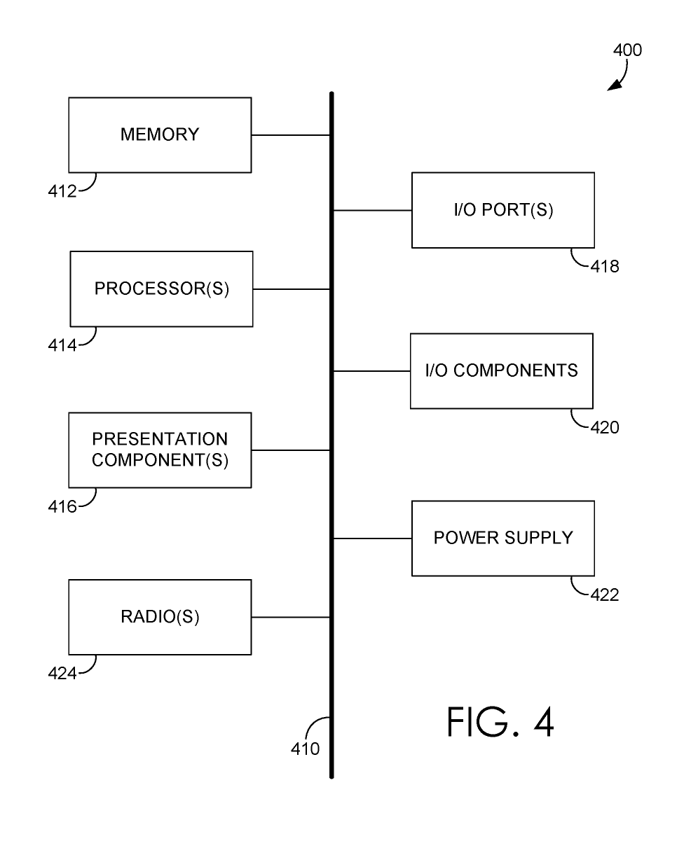

Having described an overview of embodiments of the present invention, an exemplary operating environment in which embodiments of the present invention may be implemented is described below in order to provide a general context for various aspects of the present invention. Referring initially to FIG. 4 in particular, an exemplary operating environment for implementing embodiments of the present invention is shown and designated generally as computing device 400. Computing device 400 is but one example of a suitable computing environment and is not intended to suggest any limitation as to the scope of use or functionality of the invention. Neither should the computing device 400 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 4, computing device 400 includes a bus 410 that directly or indirectly couples the following devices: memory 412, one or more processors 414, one or more presentation components 416, input/output ports 418, input/output components 420, and an illustrative power supply 422. Bus 410 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 4 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 400. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 412 includes computer storage media in the form of volatile and/or nonvolatile memory. The memory may be removable, non-removable, or a combination thereof. Exemplary hardware devices include solid-state memory, hard drives, optical-disc drives, etc. Computing device 400 includes one or more processors that read data from various entities such as memory 412 or I/O components 420. Presentation component(s) 416 present data indications to a user or other device. Exemplary presentation components include a display device, speaker, printing component, vibrating component, etc. Then memory 412 may include program instructions, that when executed by one or more processors, cause the one or more processors to perform any operation described herein, such as the process 300 of FIG. 3 or any functions/operations as described with respect to FIG. 1 and FIG. 2

I/O ports 418 allow computing device 400 to be logically coupled to other devices including I/O components 420, some of which may be built in. Illustrative components include a microphone, joystick, game pad, satellite dish, scanner, printer, wireless device, etc.

Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed.

In various embodiments, the computing device 400 is or is included in various components described herein. For example, the client device 105, the terminal processing device 101, the acquisition device 120, the application service device 103, the verifying device 140, the UDE processing device 130, and/or the merchant device 207 as described herein can be embodied in the computing device 400 and/or components of the computing device 400 in accordance with various embodiments.

Implementations of the invention may be made in hardware, firmware, software, or any suitable combination thereof. Implementations of the invention may also be implemented as instructions stored on a machine-readable medium, which may be read and executed by one or more processors. A tangible machine-readable medium may include any mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions. As noted above, various components described herein can be alternatively embodied in hardware or firmware, such that any one of the components are designed to perform the specialized functions described in accordance with the present disclosure.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A computer-implemented method for securing multi-part CAV transactions, the method comprising:
receiving, by a computing device, a pre-authorization request from an acquisition device configured to generate the pre-authorization request based on an initiated pre-authorization transaction, the received pre-authorization request including an encrypted CAV and defining a total amount associated with the initiated pre-authorization transaction;
generating, by the computing device, a verification request based on the encrypted CAV included in the received pre-authorization request and the defined total amount associated with the initiated pre-authorization transaction;
communicating, by the computing device, the generated verification request to a remote computing device, wherein the remote computing device is configured to generate a verification response based at least in part on a verification of the encrypted CAV;
responsive to receiving the generated verification response from the remote computing device, generating, by the computing device, a unique data element associated with the received verification response;
communicating, by the computing device, the generated unique data element associated with the received verification response to the acquisition device;
receiving, by the computing device, a first processing request from the acquisition device, the received first processing request including the communicated unique data element and a defined first amount; and p1 generating, by the computing device, an authorization message corresponding to the received first processing request based on a determination that the received first processing request includes the communicated unique data element and that the defined first amount is less than the defined total amount.

2. The computer-implemented method of claim 1, wherein the received first processing request does not include the encrypted CAV.

3. The computer-implemented method of claim 1, further comprising:
in response to generating the authorization message, causing the defined first amount to be transferred without further verifying the received first processing request.

4. The computer-implemented method of claim 1, further comprising:
receiving, by the computing device, a second processing request from the acquisition device, the received second processing request including the communicated unique data element and a defined second amount; and
generating, by the computing device, another message corresponding to the received second processing request based at least in part on another determination that the received second processing request includes the communicated unique data element.

5. The computer-implemented method of claim 4, wherein the other message is generated based further in part on a third determination that a calculated sum of the defined first amount and the defined second amount is less than or equal to the defined total amount, the other message being an authorization message.

6. The method of claim 4, wherein the other message is generated based further in part on a fourth determination that a calculated sum of the defined first amount and the defined second amount is greater than the defined total amount, the other message being a declined message.

7. The computer-implemented method of claim 1, wherein the CAV corresponds to a personal identification number (PIN).

8. The method of claim 1, the unique data element comprising a pre-defined secret or private key.

9. A computerized system comprising:
one or more processors; and
one or more computer storage media storing computer-usable instructions that, when used by the one or more processors, cause the one or more processors to:
receive a pre-authorization request from an acquisition device configured to generate the pre-authorization request based on an initiated pre-authorization transaction, the received pre-authorization request including an encrypted CAV and defining a total amount associated with the initiated pre-authorization transaction;
communicate, to a remote computing device, a generated verification request that includes the encrypted CAV and the defined total amount associated with the initiated pre-authorization transaction;
communicate, to the acquisition device, a unique data element that is generated in response to receiving, from the remote computing device, an authorization approval corresponding to the communicated verification request;
generate an authorization message that corresponds to a first processing request received from the acquisition device based on a determination that the received first processing request includes the communicated unique data element and defines a first amount determined less than the defined total amount.

10. The system of claim 9, wherein the instructions further cause the one or more processors to:
generate another message that corresponds to a second processing request received from the acquisition device based on another determination that the received second processing request includes the communicated unique data element and defines a second amount determined less than the defined total amount.

11. The system of claim 10, wherein the other message is generated based further on determining that a calculated sum of the defined first amount and the defined second amount is less than or equal to the defined total amount, the other message being another authorization message.

12. The system of claim 10, wherein the other message is generated based further on determining that a calculated sum of the defined first amount and the defined second amount is greater than the defined total amount, the other message being a decline message.

13. The system of claim 9, wherein the CAV corresponds to a personal identification number (PIN).

14. The system of claim 9, wherein the unique data element includes a pre-authorization approval indicator for the defined total amount, a pre-defined secret, and a private key.

15. One or more non-transitory computer-readable media including one or more instructions that, when executed by one or more processors, cause the one or more processors to:
receive a pre-authorization request from a first computing device configured to generate the pre-authorization request based on an initiated pre-authorization transaction, the received pre-authorization request including an encrypted CAV and defining a total amount associated with the initiated pre-authorization transaction;
generate a verification request based on the encrypted CAV included in the received pre-authorization request and the total amount defined by the received pre-authorization request;
communicate the generated verification request to a second computing device, wherein the second computing device is configured to generate a verification response based at least in part on the communicated verification request;
communicate, to the first computing device, a unique data element that is generated based on receiving the generated verification response from the second computing device, the generated unique data element being associated with the received verification response;
receive a first processing request that includes the communicated unique data element from the first computing device; and
generate an authorization message corresponding to the received first processing request based on a determination that the received first processing request includes the communicated unique data element and defines a first amount determined less than the defined total amount.

16. The one or more computer-readable media of claim 15, wherein a CAV corresponds to a personal identification number (PIN).

17. The one or more computer-readable media of claim 15, the unique data element comprising a pre-defined secret or private key.

18. The one or more computer-readable media of claim 15, wherein the one or more instructions further cause the one or more processors to: cause the defined first amount to be transferred without further verifying the received first processing request.

19. The one or more computer-readable media of claim 18, wherein the one or more instructions further cause the one or more processors to:
receive a second processing request from the first computing device, the second processing request including the communicated unique data element and defining a second amount less than the defined total amount;
generate an authorization message corresponding to the received second processing request based on another determination that the received second processing request includes the communicated unique data element and that a calculated sum of the defined first amount and the defined second amount is less than or equal to the defined total amount.

20. The one or more computer-readable media of claim 19, wherein the one or more instructions further cause the one or more processors to:
cause the defined second amount to be transferred without further verifying the received second processing request.
